(19) United States
(12) Patent Application Publication
(10) Pub. No.: US 2012/0234906 A1
(43) Pub. Date: Sep. 20, 2012

(54) PARKING SYSTEM AND METHOD

(76) Inventor: Hariraam Varun Ganapathi, Palo Alto, CA (US)

(21) Appl. No.: 13/047,194

(22) Filed: Mar. 14, 2011

(51) Int. Cl. G06F 17/00

(52) U.S. Cl. 235/375

(57) ABSTRACT

The present invention provides for a feature-rich parking system and implements a low-cost, low-technology presence at the parking location. In an embodiment, a parking pole is placed adjacent to a parking space where the parking pole includes a code, including a bar code, QR code, or NFC label that is designed to be identified and processed by a mobile communication device such as a cell phone or smart phone. The processed information can then be wirelessly communicated by the mobile communication device to a remotely situated server that can process a payment for the use of the desired parking space.

### FIELD OF THE INVENTION

The present invention generally relates to the field of computerized monitoring and payment. More particularly, the present invention relates to an improved method and system for monitoring parking and receiving payment for such parking.

### BACKGROUND OF THE INVENTION

Since their introduction, parking meters have been used by municipalities and other organization to collect money in exchange for the right to park a vehicle in a particular place for a limited amount of time. Parking meters are used by municipalities as a tool for enforcing their parking policies. Parking meters have also been used by private entities to manage large and small scale parking facilities.

As shown in FIG. 1, a parking meter 102 has traditionally been placed along a parking location 104 where an automobile 106 may be parked. Where a user 108 desires to park, he deposits coins in parking meter 102. Parking meter 102 is further equipped with a visible indication 110 of valid or expired parking.

Recently, however, parking meters have been infused with technology. For example, parking meters have been enhanced to accept credit cards or smart cards. For such operation, parking meters have also been enhanced with communication technology so as to be able to validate the payment methods. Still other parking meters have been enhanced to be able to detect the presence of an automobile in a predetermined space.

Other advances in parking meter technology have included collective pay and display machines that control multiple spaces per block or an entire lot. Such machines are essentially a complex computer that includes a database of parking spaces, the ability to receive and process payments, and the ability to print receipts to be displayed as well as touch screen displays, for example.

Powering these modern parking meters with all their technology then also becomes an issue. Whereas low-powered meters may be powered by batteries, more complex meters require a constant electrical source that requires maintenance from time-to-time. Other parking meters implement expensive solar power that is susceptible to damage from natural elements, vandalism, and even automobile accidents.

The above-described parking meters have sought to implement some of the advances in computer technology onto the parking meter. This approach has led to meters with many features but has also led to very expensive meters.

Therefore, there is a need to provide a low cost parking method and system with a substantially reduced cost with conveniences and desirable features for a consumer as well as conveniences and desirable features for those that monitor the parking meters (e.g., police).

### SUMMARY OF THE INVENTION

The present invention provides for a feature-rich parking system and implements a low-cost, low-technology presence at the parking location. In an embodiment, a parking pole is placed adjacent to a parking space where the parking pole includes a label, including a bar code, QR code, or NFC target, for example, that is designed to be identified and processed by a mobile communication device such as a cell phone or smart phone. The processed information can then be wirelessly communicated by the mobile communication device to a remotely situated server that can process a payment for the use of the desired parking space.

In keeping track of the time available for valid parking, the remotely situated server is further configured to send messages (e.g., email or text messages) to a user as the expiration time approaches as well as when expiration has occurred. As the expiration time approaches, a user is able to add time as necessary. Where applicable, a user may further receive messages that a maximum parking time may be approaching beyond which he will not be able to pay and must move his automobile. Such an embodiment can further indicate the applicable laws regarding re-parking. For example, there may exist certain laws that prohibit re-parking within ¼ of a mile of the same space. Such a message can be displayed in as a first parking time approaches. Also, a similar message can be displayed if the user attempts to re-park in a space that would result in a violation. In such a situation, the user could be prohibited from making the second purchase for time in an invalid location.

Other features of the present invention include the distribution of information to parking enforcement officers. For example, where the remotely situated server has valid and expired parking information for a municipality, such information can be distributed to parking enforcement officers. With such information, the activities of the parking enforcement officers can be optimized. For example, a parking enforcement officer would not need to constantly patrol the streets. Instead, an officer could receive information from the remotely situated server about violations and could proceed to such locations directly.

Other embodiments include the ability to photograph and register identifying information about a vehicle (e.g., a license plate or vehicle identification number) that could be transmitted to the remotely situation server along with parking space information so that the two items of information can be correlated. This embodiment would avoid the situation where a second automobile parks in a space that has been paid for a first automobile.

The present invention, therefore, provides a feature-rich parking system that is implemented with a low-cost presence at the parking location. Indeed, in an embodiment, only a pole without need for power or communication along with an identifying code is necessary at the parking location. These and other aspects of the invention will be better appreciated upon an understanding of the detailed description below.

### BRIEF DESCRIPTION OF THE DRAWINGS

The following drawings will be used to more fully describe embodiments of the present invention.

FIG. 1 is a parking system according to the prior art.

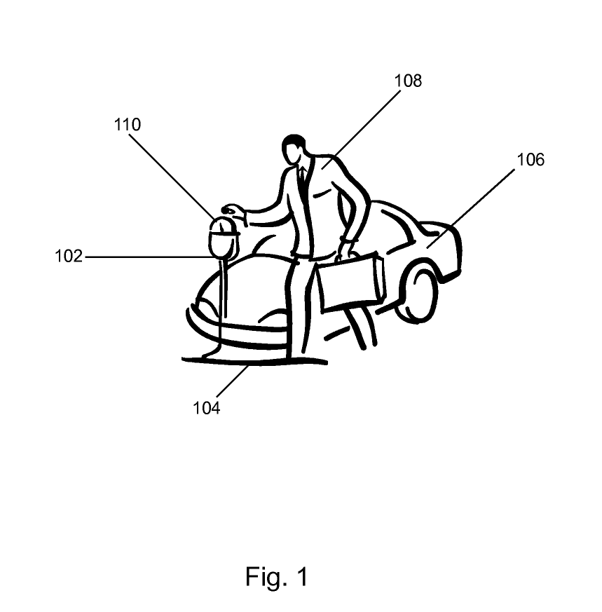

FIG. 2 is an embodiment of a parking system according to an embodiment of the invention.

FIG. 3 is an embodiment of a parking system according to an embodiment of the invention.

FIG. 4 is an embodiment of a parking system according to an embodiment of the invention.

FIG. 5 is an embodiment of a passive station according to an embodiment of the invention.

FIG. 6 is an embodiment of a computer system as may be used to implement the present invention.

### DETAILED DESCRIPTION OF THE INVENTION

The following description is of certain preferred embodiments presently contemplated for carrying out this invention. This description is made for the purpose of illustrating the general principles of this invention and is not meant to limit the inventive concepts claimed herein.

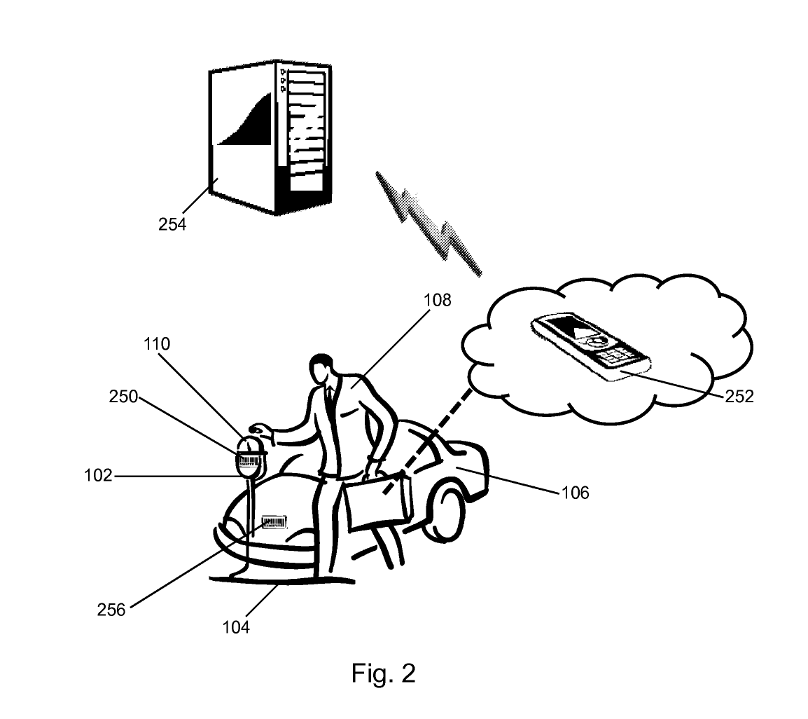

An embodiment of the invention is shown in FIG. 2 that includes a parking location identification label 250 that can be photographed with a camera-equipped mobile communication device 252 that can be wirelessly communicatively coupled to remote server 254. As shown in FIG. 2, where a user 108 desires to park his automobile 106 at parking location 104, the user can photograph identification label 250 with his camera-equipped mobile communication device 252 so as to identify the parking location 104 and then proceed to pay for the right to park.

In an embodiment, identification label 250 is a bar code or QR code. But identification label 250 can be any other label that can be photographed and visually identified to be used to uniquely identify parking location 104.

Identification label 250 can also be a label or device that can communicate information to communication device 252. For example, identification label 250 can include an RFID device that can be detected by communication device 252. Still another embodiment of the invention can implement other forms of communication, including, for example, short range wireless technology such as Near Field Communication (NFC). In NFC, the typical range of communication is limited to a few inches with a data rate of several hundred kilobits per second. Communication device 252 can be implemented with NFC technology to be an initiator in an NFC implementation. In being an initiator, communication device 252 generates an RF field that can power a passive target that can be implemented as identification label 250. In a similar manner as bar codes or QR codes, NFC targets can be simple and small form factors that can further be implemented at a low cost. Importantly, NFC targets that are implemented as identification label 250 do not need external power.

In an embodiment, mobile communication device 252 is equipped with a software application (e.g., “mobile app”) that is configured to process identification label 250. Such processing can include cropping and executing image enhancement algorithms so as to identify the presence of identification label 250. For example, where a photograph taken by user 108 may include more than the identification label 250, the app can eliminate unnecessary image information, concentrate on only the identification label 250, and process the image for optimized processing of identification label 250. The software application can include other algorithms such as algorithms for further processing the identification label to identify the parking location 104.

In another embodiment, identifying information about automobile 106 can also be photographed by communication device 252. Such identifying information can include license plate or vehicle identification number information. Also, automobile 106 can be equipped with identification label 256 that is substantially similar to identification label 250. Accordingly, identification label 256 may be a bar code, QR code, NFC target, or other information or device that can be provide information to communication device 252. In this embodiment, the parking location 104 information can thereby be correlated to the automobile 252 and can be further correlated to user 108. In the present invention, many of the algorithms described as performed by communication device 252 can also be implemented by remote server 254 and vice versa.

In an embodiment, information about parking location 104 such as identification label 250 is transmitted to remote server 254. Also, information about automobile 106 such as identification label 256 is transmitted to remote server 254. Likewise, information about user 108 is also transmitted to remote server 254. Information about user 108 can be obtained at the time of each use of the system or can be stored, for example, in communication device 252, so as to be readily available for use.

Upon receipt of information regarding parking location 104, automobile 106, and user 108, remote server is configured to determine the applicable parking rates. Such information can be relayed to user 108 via communication device 252. Subsequently, a user can make appropriate choices about the length of the desired parking and the amount desired to be paid that can be transmitted to remote server 254 for payment processing.

In an alternative embodiment, user 108 does not prepay for parking but instead apprises the system of the present invention that he is parked at a parking location. In this embodiment payment is made after user 108 is ready to discontinue use of the parking location. User 108, therefore, pays only for the amount of time used and does not have to guess as to how much time may be used. In this embodiment, a user that does not properly check out and pay for the parking time used could be charged as a default for a maximum possible time.

In yet another embodiment of the invention, user 108 pre-configures an account with remote server 254, for example, through the use of a web site. Such account information can include identifying information about user 108 as well as payment information such as credit card or bank account information. Among other things, this embodiment provides the advantage that user information that must be transmitted during a parking transaction is minimized. Also, sensitive user and account information need not be retained or communicated by communication device 252, thereby adding a level of security.

In another embodiment of the invention, an application on communication device 252 is configured to store user 108 information, including some of the same identifying and payment information as described above. In such an embodiment, user 108 information need not be retained at remote server 254 and could provide security advantages because information is not retained at remote server 254.

Upon processing, parking location 104 is tagged as paid for a predetermined time where such information is processed and retained by remote server 254. Some or all of such information can also be communicated to communication device 252. With such information, remote server 254 (or communication device 252) can generate messages as the parking expiration time approaches. As the parking expiration time approaches, user 108 can be prompted to initiate another transaction to increase the allowed time for parking.

Other messages can also be generated either by remote server 254 or communication device 252. For example, where a maximum time for parking is approaching beyond which a user may no longer be able to pay for further parking, an informative message could be generated and displayed. Such message could also include useful information about parking laws. For example, a user 108 may be required to find a second parking location beyond a certain distance from the first parking location. Also, remote server 254 could provide information about closely located open parking locations.

In an embodiment, remote server 254 processes and collects information about many parking locations. Such information can be transmitted and used by a user 108 or a parking enforcement officer.

For example, user 108 can receive information from remote server 254 via communication device 252 about nearby parking locations. A user could manually transmit his location using, for example, cross street or address information. Also, a user's location could be automatically transmitted using, for example, GPS or transmitter tower information. A text-based listing of available spaces could be presented. Also, a graphical map could be presented identifying available parking locations.

Remote server 254 could also transmit parking location information to parking enforcement officers. In such an embodiment, a parking enforcement officer could be presented with a text-based list or graphical map with an indication where parking violations have occurred or may soon occur. Accordingly, a parking enforcement officer could directly go to parking locations with automobiles that are in violation of parking laws without the need to roam a large area in search of violators.

In another embodiment, parking location information is transmitted to a device operated by a parking enforcement officer. Such device can automatically take pictures of (or scan) identification labels 250 for the parking locations and other identifying information (e.g., license plate or identification label 256) about the automobiles parked at a give parking location. In this way, a parking enforcement office is able to correlate payment for a parking location with an appropriate automobile. An unauthorized automobile at a parking location for which another user has made payment could, therefore, result in a violation and citation.

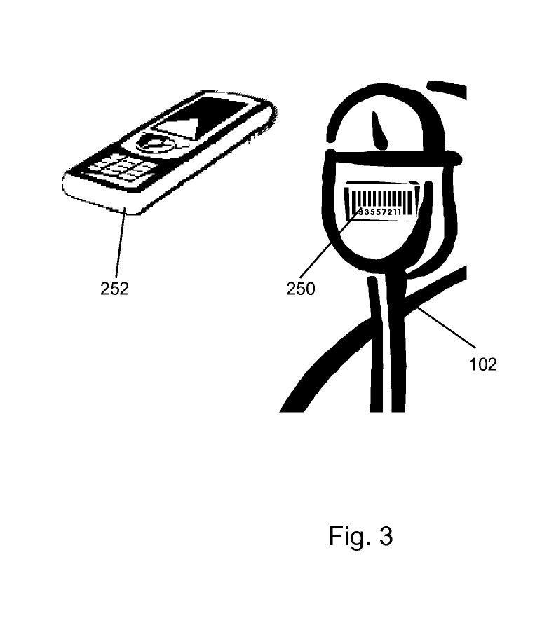

In an embodiment of the invention, for example, where parking meters 102 may already exist, the present invention can be implemented in a low-cost manner by affixing identification labels 250 on the pre-existing parking meters 102 as shown in FIG. 3. In such an embodiment, communication device 252 can readily photograph identification label 250 by a user for processing as described herein.

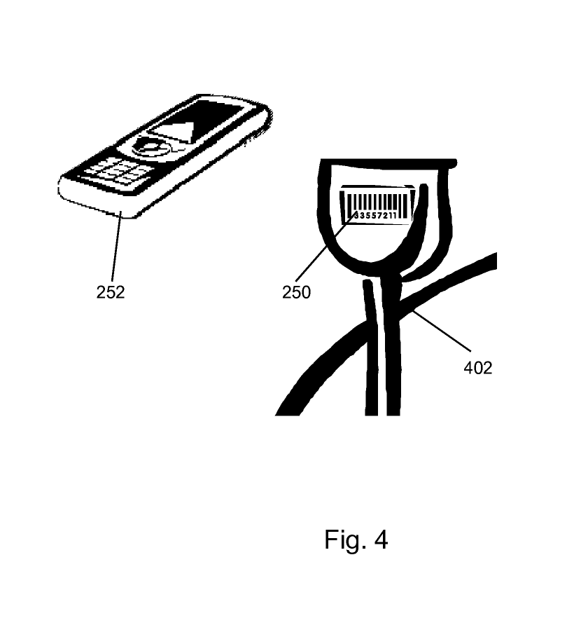

The present invention, however, can also be implemented in a low-cost manner where parking meters may not already exist. For example, as shown in FIG. 4, a parking pole 402 is erected adjacent to a parking location where parking pole 402 has affixed to it identification label 250. When affixed to parking pole 402, communication device 252 can readily photograph identification label 250 for processing as described herein.

In yet another embodiment, identification label 250 can also be affixed along the edge of a sidewalk or street without need for erecting a pole. While such an embodiment is of even lower cost than implementation of parking pole 402, this embodiment can introduce other undesirable issues. For example, bending over to photograph or scan a label on a sidewalk can be inconvenient or uncomfortable for some users. Also, identification labels 250 could be more prone to damage if placed on the sidewalk or ground. Nevertheless, such an embodiment in feasible.

In yet another embodiment of the invention, a user could be able to prepay for and reserve a parking location. For example, as a user approaches an area of a city, the user could query remote server 254 for available locations. For a desirable parking location, a user could then proceed to pay for the parking location and thereby hold it until he arrives. This embodiment avoids, among other things, wasteful driving around a neighborhood in search of a parking location. Because a parking location is reserved, server 254 would not allow another user to be able to pay for and take the identified parking location. As necessary, a parking enforcement officer or towing service could be summoned upon the improper use of the reserved location.

The present invention provides other advantages. Pollution can be reduced because users would not need to roam a neighborhood in search of a parking space. Likewise parking enforcement officers would not need to roam a neighborhood in search of violators; they could simply be directed to a violation by server 254. Of course, energy consumption is also reduced by avoiding wasteful driving.

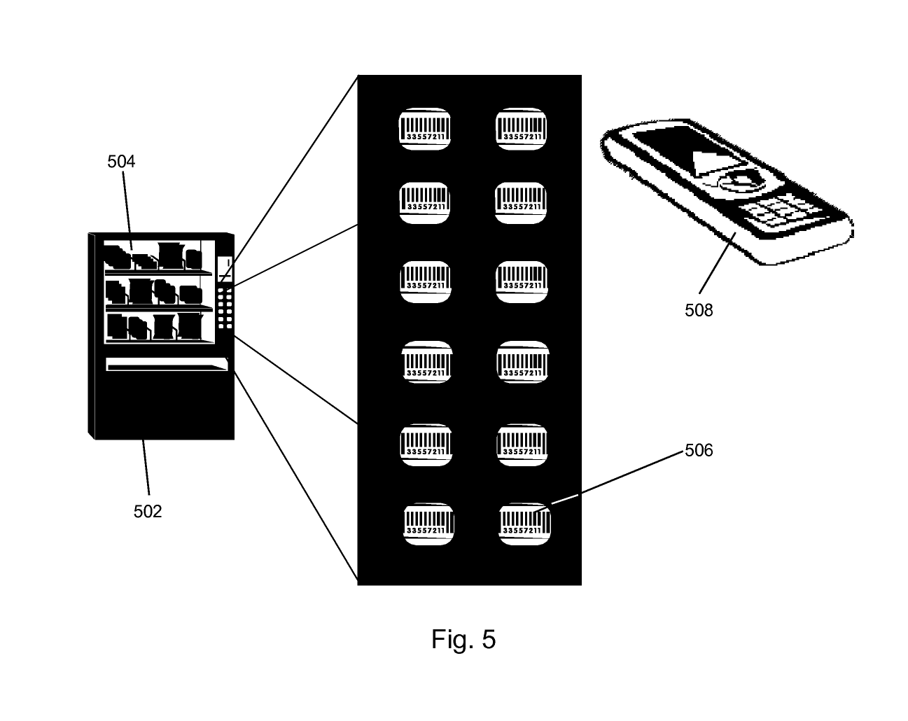

The present invention lends itself to many other applications beyond parking including other passive station scenarios. For example, as shown in FIG. 5, vending machine 502 is stocked with multiple types of merchandise 504 that can be dispensed to a user. In this embodiment, affixed on vending machine 502 are multiple identification labels 506 that are correlated to the multiple types of merchandise 504 at predetermined prices. Where a user desires to purchase one of multiple types of merchandise 504, the user can photograph or scan the appropriate identification label 506 using communication device 508 as described more fully above. Appropriate vending machine 502, merchandise 504, and user information can be transmitted to a remote server as described previously for processing and payment also as described above.

Upon the processing of payment, vending machine 502 could then be directed to dispense the desired merchandise 504. Such direction could be initiated by a remote server communicating with vending machine 502 and providing an instruction to dispense the desired merchandise 504. In another embodiment that avoids a communication link between a remote server and vending machine 502, a user could receive a unique, use-once code that could be input to vending machine 502 for dispensing the desired merchandise 504. In yet another embodiment, communication device 508 could responsively generate a visual code that could be scanned by vending machine 502. In still another embodiment of the invention, a communication link (e.g., a Bluetooth link) could be established between communication device 508 and vending machine 502 where the communication link could transmit the appropriate information to allow vending machine 502 to dispense the desired merchandise.

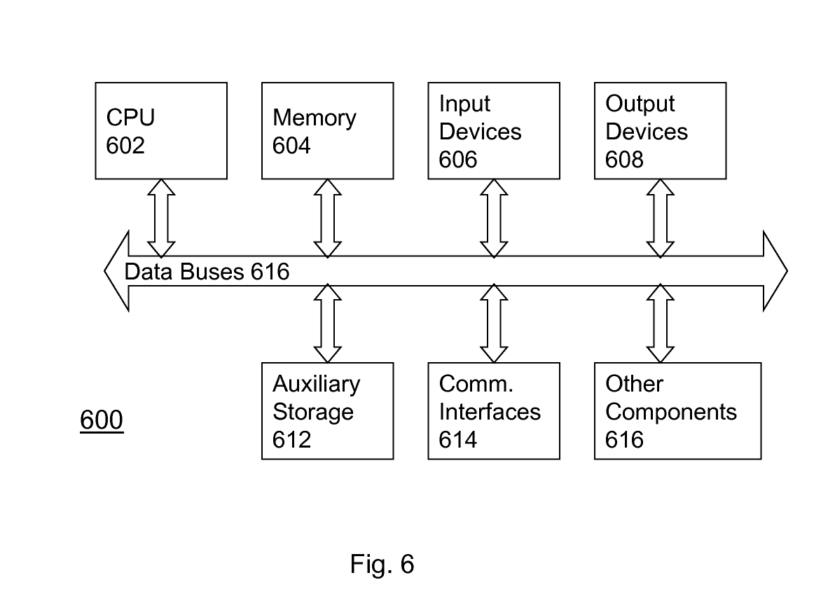

As described, the present invention relates to methods, techniques, and algorithms that are intended to be implemented in a digital computer system 600 such as generally shown in FIG. 6. For example, remote server 254 can be implemented with computer system 600. Also, communication device 252 (or communication device 508) can be implemented using a variation of computer system 600.

Computer system 600 may include at least one central processing unit 602 but may include many processors or processing cores. Computer system 600 may further include memory 604 in different forms such as RAM, ROM, hard disk, optical drives, and removable drives that may further include drive controllers and other hardware. Auxiliary storage 612 may also be include that can be similar to memory 604 but may be more remotely incorporated such as in a distributed computer system with distributed memory capabilities.

Computer system 600 may further include at least one output device 608 such as a display unit, video hardware, or other peripherals (e.g., printer). At least one input device 606 may also be included in computer system 600 that may include a pointing device (e.g., mouse), a text input device (e.g., keyboard), a camera, or touch screen.

Communications interfaces 614 also form an important aspect of computer system 600 especially where computer system 600 is deployed as a distributed computer system such as remote server 254 (FIG. 2). Computer interfaces 614 may include LAN network adapters, WAN network adapters, wireless interfaces, Bluetooth interfaces, modems and other networking interfaces as currently available and as may be developed in the future.

Computer system 600 may further include other components 616 that may be generally available components as well as specially developed components for implementation of the present invention. Importantly, computer system 600 incorporates various data buses 616 that are intended to allow for communication of the various components of computer system 600. Data buses 616 include, for example, input/output buses and bus controllers.

Indeed, the present invention is not limited to computer system 600 as known at the time of the invention. Instead, the present invention is intended to be deployed in future computer systems with more advanced technology that can make use of all aspects of the present invention. It is expected that computer technology will continue to advance but one of ordinary skill in the art will be able to take the present disclosure and implement the described teachings on the more advanced computers as they become available. Moreover, the present invention may be implemented on one or more distributed computers.

Still further, the present invention may be implemented in various types of software languages including C, C++, and others. Also, one of ordinary skill in the art is familiar with compiling software source code into executable software that may be stored in various forms and in various media (e.g., magnetic, optical, solid state, etc.). One of ordinary skill in the art is familiar with the use of computers and software languages and, with an understanding of the present disclosure, will be able to implement the present teachings for use on a wide variety of computers. For example, one of ordinary skill in the art is able to write software code that implements the teachings of the present invention, including the appropriate memory structure and tags to manage the necessary information to be handled.

It should be appreciated by those skilled in the art that the specific embodiments disclosed above may be readily utilized as a basis for modifying or designing other embodiments. For example, one of ordinary skill would readily understand that the present invention can be implemented in other passive station scenarios such as bus stations, toll booths, and ticket counters, among others. It should also be appreciated by those skilled in the art that such modifications do not depart from the scope of the invention as set forth in the appended claims.

What is claimed is:

1. A computer-implemented method for a parking monitoring system, comprising:
receiving information from a parking location label;
receiving information from a vehicle label;
receiving user information;
generating a payment tag from the information from the parking location label, the information from the vehicle label, and the user information.

2. The method of claim 1, wherein the information from the parking location label is an image of the parking location label.

3. The method of claim 1, wherein the parking location label is an NFC target.

4. The method of claim 1, wherein the information from the vehicle label is an image of the vehicle label.

5. The method of claim 1, wherein the vehicle label is a license plate.

6. The method of claim 1, wherein the vehicle label is a vehicle identification label.

7. The method of claim 1, wherein the vehicle label is a label affixed to a vehicle.

8. The method of claim 1, wherein the parking location label includes a barcode.

9. The method of claim 1, wherein the parking location label includes a QR code.

10. The method of claim 1, further comprising generating messages responsive to at least one of the information from the parking location label, the information from the vehicle label, and the user information.

11. The method of claim 1, further comprising generating violation tags upon the expiration of the payment tag.

12. A computer-implemented method for operating a vending machine, comprising:
receiving information from a vending machine label;
receiving information from a merchandise label;
receiving user information;
generating a payment tag from the information from the vending machine label, the information from the merchandise label, and the user information.

13. The method of claim 1, wherein the information from the vending machine label is an image of the vending machine label.

14. The method of claim 1, wherein the parking location label is an NFC target.

15. The method of claim 1, wherein the information from the merchandise label is an image of the merchandise label.

16. The method of claim 1, wherein the merchandise label is a bar code affixed to the merchandise.

17. The method of claim 1, wherein the merchandise label is a label affixed the vending machine.

18. The method of claim 1, wherein the vending machine label includes a barcode.

19. The method of claim 1, wherein the vending machine label includes a QR code.

20. The method of claim 1, further comprising communicating the payment tag to the vending machine.

21. The method of claim 1, further comprising generating a payment label configured to be scanned by the vending machine.

22. The method of claim 1, further comprising generating a payment code configured to be input to the vending machine.
